(19) United States
(12) Patent Application Publication
(10) Pub. No.: US 2009/0280213 A1
(43) Pub. Date: Nov. 12, 2009

(54) Production and use of Anka-polyphenol containing broth

(75) Inventors: Tzann Feng Lin, Taipei (TW); Chih Shen Chang, Taipei (TW)

Correspondence Address: BIRCH STEWART KOLASCH & BIRCH, PO BOX 747, FALLS CHURCH, VA, 22040-0747, US

(73) Assignee: TAIWAN TOBACCO & LIQUOR CORPORATION

(21) Appl. No.: 12/149,997

(22) Filed: May 12, 2008

(51) Int. Cl. C11B 5/00; A23L 1/105; A23F 5/14

(52) U.S. Cl. 426/28; 426/18; 426/595; 426/541

(57) ABSTRACT

The present invention is related to a process for producing an Anka-polyphenol containing broth with high antioxidant activity, comprising saccharifying and then fermenting raw rice with a Monascus purpureus BCRC 930109 strain, to produce a fermentative broth having high antioxidant activity, high Anka-polyphenol and high amino acid contents. The Anka-polyphenol containing broth can be added to a coffee drink to enhance its antioxidant activity and eliminate its bitter and sour tastes.

### TECHNICAL FIELD

The present invention relates to production and use of an Anka-polyphenol containing broth, wherein a Monascus purpureus strain with high antioxidant activity is used to produce a fermentative broth having high antioxidant activity, high Anka-polyphenol and high amino acid contents. Said fermentative broth can be added to a coffee drink to enhance its antioxidant activity and improve its flavor and-taste.

### BACKGROUND OF THE INVENTION

Use of Anka (red koji; red mold rice) in alcohol fermentation can be seen only in China. A Chinese traditional wine, aged Fujian rice wine, is prepared by a steamed-rice spreading method, which comprises spreading steamed glutinous rice on a bamboo screen and allowing it to dry in air; portionwisely blending red koji and white koji into the cooled glutinous rice; loading the fermentative mash into a bag filter and pressing the bag to squeeze out fermentative broth; then deactivating the enzymes and microorganisms in the fermentative broth at an elevated temperature. The steamed-rice spreading method as stated above, owing to that long processing time, large operating area and much labor are needed and the product is easy to be contaminated by other bacteria, is now replaced by Amylo process. In Amylo process, fermentation is performed in a closed space and thus contamination by other bacteria can be reduced. Amylo process comprises the following steps: steaming, digesting starch and then cooling the liquefied broth; portionwisely adding mold (Rhizopus spp.), yeast and Anka to perform saccharification and fermentation; portionwisely adding rice wine to perform maceration and portionwisely extracting the supernant; loading the fermentative mash into a bag filter and pressing the fermentative broth (liquid part) out of the bag filter so as to separate the fermentative broth from dregs (solid part); combining the fermentative broth pressed out and several supernants obtained from the previous step and removing the suspended particles in the resulting mixture; and deactivating the enzymes and microorganisms in the mixture at an elevated temperature. Amylo process needs shorter fermentation time (about 2˜3 weeks) when compared with the steamed-rice spreading method.

Anka has vivid color, aromatic flavor and sweet taste; therefore, it was mainly used in coloring food products and producing rice wine in early time. Recently, it was found that the secondary metabolites of Anka comprise substances that can inhibit the synthesis of cholesterol, decrease the blood pressure, anti-spoilage bacteria, anti-cancer, antioxidant or decrease the blood sugar. Therefore, Anka has been used in development of foods and drinks for health care. However, the proportions of these health care ingredients in Anka may vary with different strains of Monascus. For example, one strain of Monascus may produce higher proportion of cholesterol synthesis-inhibiting ingredient, while another strain may produce higher proportion of ingredient decreasing the blood pressure.

### SUMMARY OF INVENTION

The main object of the present invention is a process for producing an Anka-polyphenol containing broth with high antioxidant activity, high Anka-polyphenol and high amino acid contents.

Another object of the present invention is use of the Anka-polyphenol containing broth as an additive in a coffee drink to enhance its antioxidant activity and improve its taste and flavor.

To achieve the above objects, the process according to the present invention comprises the following steps: steaming glutinous rice at 95˜99° C.; liquifying the steamed rice with thermo-stable α-amylase at 95° C.˜100° C. for 30 minutes; cooling the liquified rice to 58° C.˜64° C. and adding an Anka with high antioxidant activity (comprising Monascus purpureus BCRC 930109 strain ); performing saccharification at 50° C.˜60° C. for 2 to 3 hours; cooling the saccharified product to 26° C.˜30° C. and allowing it to perform yeast proliferation and alcohol fermentation for 2 to 3 days; supplementing additional steamed rice according to the desired brix (sugar content), and continuing yeast proliferation and alcohol fermentation for another 10 to 14 days; and pressing out the fermentative broth. According to the above steps, an Anka-polyphenol containing broth with high oxidant activity can be obtained.

The process of the present invention may further comprise the step of varying the antioxidant activity, polyphenol, sugar, alcohol and amino acid contents of the fermentative broth by adjusting the ratio of the raw rice used to the total amount of mash. For example, the Anka-polyphenol containing broth produced by the process of the present invention may be a dry type of Anka-polyphenol containing broth comprising 28˜33% of rice (calculated as raw rice used) based on the total amount of mash, and having an antioxidant acitivity of 7˜10 TEAC/ml as measured by a DPPH radical elimination method and a brix of 0.5% or less; a semi-dry type of Anka-polyphenol containing broth comprising 34˜37% of rice (calculated as raw rice used) based on the total amount of mash, and having an antioxidant activity of 9˜13 TEAC/ml as measured by a DPPH radical elimination method and a brix of 0.5˜3.0%; a semi-sweet type of Anka-polyphenol containing broth comprising 38˜43% of rice (calculated as raw rice used) based on the total amount of mash, and having an antioxidant activity of 11˜15 TEAC/ml as measured by a DPPH radical elimination method and a brix of 3.0˜9.9%; or a sweet type of Anka-polyphenol containing broth comprising 44˜50% of rice (calculated as raw rice used) based on the total amount of mash, and having an antioxidant activity of 13˜18 TEAC/ml as measured by a DPPH radical elimination method and a brix of 10% or more.

It has been found in some researches that coffee has higher antioxidant activity than green tea and is more effective in slowing aging and preventing cardiovascular diseases. It was considered in the past that drinking excess coffee might lead to increased incidence rate of cardiovascular diseases; however, the recent scientific evidences indicated that sugar and milk, which were added to coffee to reduce its bitter taste, were main contributor to increased incidence rate of cardiovascular diseases caused by excess coffee intake. Thus, the inventor tried to add the Anka-polyphenol containing broth with high antioxidant activity produced by the process of the present invention, to coffee drink, and found that the coffee drink not only had enhanced antioxidant activity, but also had less bitter and sour tastes and more pleasant aromatic flavor. Furthermore, the Anka-polyphenol containing broth of the present invention itself has certain brix; therefore, the coffee drink with the fermentative broth of the present invention added thereto, no more need addition of sugar and milk, such that coffee drinkers can enjoy good taste of coffee without worrying about increased load on cardiovascular system caused by sugar and milk.

It can be seen from the above that the Anka-polyphenol containing broth produced by the process of the present invention has advantages such as high antioxidant activity, high Anka-polyphenol and high amino acid contents; and when the Anka-polyphenol containing broth is added to coffee drinks, not only the antioxidant activity of coffee is enhanced, but also the bitter and sour tastes of coffee can be eliminated.

These and other features and embodiments of the present invention can be further understood from the following “Description of the Invention”.

### DETAILED DESCRIPTION OF PREFERRED EMBODIMENTS

Preparation of Anka-Polyphenol Containing Broth

The Anka-polyphenol containing broth of the present invention is prepared by the following steps:
Step a): steaming glutinous rice at 95° C.˜99° C.;
Step b): liquifying the steamed rice with thermo-stable α-amylase at 95° C.˜100° C. for 30 minutes;
Step c): cooling the liquified rice to 58° C.˜64° C. and adding an Anka with higher antioxidant activity, in an amount adjusted according to the polyphenol content and fermentation degree;
Step d): performing saccharification at 50° C.˜60° C. for 2 to 3 hours;
Step e): cooling the saccharified product of the step d) to 26° C.˜30° C. and allowing it to perform yeast proliferation and alcohol fermentation for 2 to 3 days;
Step f): supplementing additional steamed rice according to the desired brix, and continuing yeast proliferation and alcohol fermentation for another 10 to 14 days; and
Step g): pressing out a fermentative broth.

The thermo-stable α-amylase in the step b) is an α-amylase which can convert starch to maltodextrin and maltose and can maintain its activity above 100° C. In contrast, the usual α-amylase has optimal activity at 68° C. and loses its activity above 85° C.

Test for the Antioxidant Activity of Monascus Strains

The Monascus strain in the Anka added in the above step c) is a wild strain of Monascus purpureus isolated from koji, which was deposited in Food Industry Research and Development Institute (Hsin-Chu, Taiwan) on Feb. 1, 2008 under accession no. BCRC 930109.

The Anka comprising Monascus purpureus BCRC 930109 strain was extracted with 70% alcohol for 24 hours, wherein the ratio of the Anka to 70% alcohol is 1:10. The particles in the extract was filtered off by using a filtering paper. The antioxidant activity of the extract was then analyzed by DPPH (2,2-diphenyl-1-picrylhydrazyl) radical elimination method. The results were reported in Table 1. As shown in Table 1, the antioxidant activity of the Anka comprising Monascus purpureus BCRC 930109 strain is 29.02±0.11 TEAC/g, which is about 4 times as high as that of the conventional Anka for use in brewing wine (7.36±0.09 TEAC/g).

TABLE 1

| | Antioxidant activity |
|---|---|
| Tested sample | (TEAC/g) |
| Conventional Anka for use in | 7.36 ± 0.09 |
| brewing wine | |
| Anka comprising Monascus | 29.02 ± 0.11 |
| purpureus BCRC 930109 strain | |

Test for the Antioxidant Activity of Anka-Polyphenol Containing Broth

In view that the Anka comprising Monascus purpureus BCRC 930109 strain used in the process of the present invention has higher antioxidant activity than the conventional Anka for use in brewing wine, it is thus expected that the fermentative broth produced by the process of the present invention has higher content of Anka-polyphenol than those produced by using the conventional Anka for use in brewing red rice wine.

To prove this, the same weight of an conventional Anka for use in brewing wine and an Anka with high antioxidant activity according to the present invention were used respectively in production of fermentative broths under the same condition. The antioxidant activity (measured by DPPH radical elimination method), polyphenol content and amino acid content of both fermentative broths were compared and the results were reported in Table 2.

TABLE 2

| | Anka fermentation | Anka-polyphenol |
|---|---|---|
| Tested sample | broth | containing broth |
| Anka type | Conventional Anka for | Anka with high |
| | use in brewing wine | antioxidant activity |
| Antioxidant activity | 8.09~9.91 | 12.88~15.31 |
| (TEAC/mL) | | |
| Polyphenol content | 3.36~3.95 | 5.93~7.25 |
| (g GAE/mL) | | |
| Amino acid content | 0.52~0.77 | 1.48~2.88 |
| (g Ala/100 mL) | | |

It can be seen from the results of Table 2, the Anka-polyphenol containing broth produced by using an Anka with high antioxidant activity according to the present invention has higher antioxidant activity, higher polyphenol and higher amino acid contents when compared with the fermentative broth produced by using the conventional Anka for use in brewing red ricewine.

Preparation of Different Types of Anka-Polyphenol Containing Broths

Various types of Anka-polyphenol containing broths with different antioxidant activity, brix and alcohol content were produced by the same procedures as stated above under a fixed total amount of mash and a fixed ratio (3:1) of the raw rice to Anka but the ratio of the raw rice to total mash were varied according to Table 3.

TABLE 3

| Ratio in amount | | | | |
|---|---|---|---|---|
| of raw rice to | Antioxidant | | Alcohol | Type of |
| total mash | acitivity | Brix | content | fermentative |
| (%) | (TEAC/mL) | (%) | (%) | broth |
| 30 | 9.56 | 0.2 | 19.9 | dry |
| 35 | 10.21 | 2.5 | 19.1 | Semi-dry |
| 40 | 11.80 | 8.0 | 18.2 | Semi-sweet |
| 45 | 12.71 | 12.0 | 16.3 | sweet |
| 50 | 15.16 | 18.0 | 15.2 | sweet |

It can be seen form the results of Table 3 that Anka-polyphenol containing broths with the desired antioxidant activity, brix and alcohol content can be obtained merely by adjusting the ratio in amount of the raw rice to total mash.

The “total amount of mash” means the summation of the total volume of rice, Anka with high antioxidant activity and water. For example, with reference to the first and second line of Table 3, for production of Anka-polyphenol containing broth with 50 L of total mash, if 15 kg (30% based on the total amount of mash) of raw rice is added, 5 kg of Anka with high antioxidant activity is used and a dry type of fermentative broth having an antioxidant activity of 9.56 TEAC/mL and a brix of 0.2% can be obtained; if 17.5 kg (35% based on the total amount of mash) of raw rice is added, 5.83 kg of Anka with high antioxidant activity is used and a semi-dry type of fermentative broth having an antioxidant activity of 10.21 TEAC/mL and a brix of 2.5% can be obtained.

Enhancement of Antioxidant Activity of Coffee Drinks

The antioxidant activity of coffee will vary with its brewing method. The Cafe Americano has lower antioxidant activity, while milled Italian coffee has higher antioxidant activity. The coffee with the Anka-polyphenol containing broth of the present invention added thereto, has been found to have higher antioxidant activity as measured by DPPH radical elimination method. For example, two cups of coffee brewed by the same method and having the same concentration of caffeine were used for test. As a result, the antioxidant activity of the coffee was found to increase 15.0˜20.0% after addition of 1% the Anka-polyphenol containing broth, as shown in Table 4.

TABLE 4

| | Antioxidant activity | | |
|---|---|---|---|
| | (TEAC/mL) | | Increase % of antioxidant activity |
| Tested | Before | After | after addition of Anka-polyphenol |
| sample | addition | addition | containing broth |
| Example 1 | 34.81 | 40.03 | 14.99% |
| Example 2 | 32.09 | 37.75 | 17.63% |
| Example 3 | 38.12 | 45.77 | 20.08% |

The tested coffee samples were all brewed by the same method as milled Italian coffee. Mixed coffee beans with medium dark roast degree were used in Example 1; Mandeling coffee beans and Brazil coffee beans both with medium roast degree were used in Example 2; and mixed coffee beans with dark roast degree were used in Example 3.

The evaluation results of the above coffee samples indicate that in case that the coffee sample contains 1˜5% of the Anka-polyphenol containing broth, its aroma is improved and its sour and bitter tastes are reduced; in case that the coffee sample contains more than 5% of the Anka-polyphenol containing broth, although the coffee sample still has good taste, the aroma of coffee will be slightly masked by the aroma of the Anka-polyphenol containing broth.

Selection of Suitable Coffee Beans and Roast Degree Thereof

Among various kinds of coffee beans with various roast degree, the coffee beans which can maintain the aroma and taste of coffee best when formulated with the Anka-polyphenol containing broth are selected according to the result of the evaluation on their flavors. The kind and the roast degree of the coffee beans that have been evaluated are listed in Table 5. The evaluation results listed in Table 5 indicate that all kinds of coffee have good compatibility with the Anka-polyphenol containing broth, and the coffee brewed from the mixed coffee beans with medium dark to dark roast degree is most suitable to formulate with the Anka-polyphenol containing broth because it has significantly increased aroma and reduced sour and bitter tastes after addition of the Anka-polyphenol containing broth thereto.

TABLE 5

| | | Difference in preference |
|---|---|---|
| | | evaluation result before and |
| | Kind of | after addition of the Anka- |
| Roast degree | coffee bean | polyphenol containing broth |
| Medium roast | Mandeling | No significant difference |
| | Blue montain | No significant difference |
| | Mandeling & Brazil | No significant difference |
| Medium dark | Mandeling | No significant difference |
| roast | Mandeling & Brazil | No significant difference |
| | Mix. | Increased user preference |
| | | after addition |
| Dark roast | Arabica | No significant difference |
| | Mandeling | No significant difference |
| | Mandeling & Brazil | No significant difference |
| | Mix. | Increased user preference |
| | | after addition |

The roast degree in Table 5 is defined by Agtron number. The roast degree is light when Agtron number above 70, medium when Agtron number is 70˜60, medium dark when Agtron number is 60˜40 and dark when Agtron number is below 40. In this experiment, it is shown that addition of the Anka-polyphenol containing broth to the milled coffee brewed from medium dark to dark roasted coffee beans with an Agtron number of 60 or less, increase the preference of the drinker who receives the test. The term “mix” in Table 5 means a mixture of Costa Rica coffee bean, Brazil Santos coffee bean, Guatemala coffee bean, Tanzania coffee bean and Mandeling coffee bean.

The Use of Dried Anka-Polyphenol Containing Broth in Drinks

The Anka-polyphenol containing broth can be produced in a form of pack by mixing it with the equal amount of excipients, then spraying dry the resulting mixture and filling the dried mixture into packs. The “Anka-polyphenol pack” thus obtained can be used to replace the sugar packs that are conventionally used in improving the flavor and taste of coffee or other drinks.

Those stated above merely represent the preferred embodiments of the present invention but do not intend to restrict the present invention. For example, the effects of the Anka-polypenol containing broth of the present invention on the flavor and taste of lots of commercially available kinds of coffee have been tested in the preferred embodiments, but this does not mean exclusion of the possibility that the Anka-polypenol containing broth may exert the same effects on other kinds of coffee. Any simple modifications and alterations of the present invention without departing from the scope of the claims would be deemed falling in the scope of the present invention.

We claim:

1. A process for producing an Anka-polyphenol containing broth with high antioxidant activity, comprising the following steps:
a. steaming raw rice at 95° C.˜99° C.;
b. liquifying the steamed rice with thermo-stable α-amylase at 95° C.˜100° C. for 30 minutes;
c. cooling the liquified rice to 58° C.˜64° C. and adding an Anka, which comprises a Monascus purpureus strain deposited in Food Industry Research and Development Institute, Hsin-Chu, Taiwan, under accession no. BCRC 930109;
d. performing saccharification at 50° C˜60° C. for 2 to 3 hours;
e. cooling the saccharified product of the step d) to26° C.˜30° C. and allowing it to perform yeast proliferation and alcohol fermentation for 2 to 3 days;
f. supplementing additional steamed rice according to the desired brix, and continuing yeast proliferation and alcohol fermentation for another 10 to 14 days; and
g. pressing out a fermentative broth.

2. The process according to claim 1, wherein the raw rice is glutinous rice.

3. The process according to claim 1, wherein the thermo-stable α-amylase is an enzyme that can convert starch to maltodextrin and maltose and still have enzyme activity above 100° C.

4. The process according to claim 1, wherein the ratio of the raw rice to Anka is 3:1.

5. The process according to claim 1, further comprising a step of varying the antioxidant activity, polyphenol content and brix of the fermentative broth by adjusting the amount of raw rice under a fixed total amount of mash.

6. The process according to claim 5, wherein the fermentative broth is a dry type of Anka-polyphenol containing broth comprising 28˜33% of raw rice based on the total amount of mash, and having an antioxidant activity of 7˜10 TEAC/ml as measured by a DPPH radical elimination method and a brix of 0.5% or less.

7. The process according to claim 5, wherein the fermentative broth is a semi-dry type of Anka-polyphenol containing broth comprising 34˜37% of raw rice based on the total amount of mash, and having an antioxidant activity of 9˜13 TEAC/ml as measured by a DPPH radical elimination method and a brix of 0.5˜3.0%.

8. The process according to claim 5, wherein the fermentative broth is a semi-sweet type of Anka-polyphenol containing broth comprising 38˜43% of raw rice based on the total amount of mash, and having an antioxidant activity of 11˜15 TEAC/ml as measured by a DPPH radical elimination method and a brix of 3.0˜9.9%.

9. The process according to claim 5, wherein the fermentative broth is a sweet type of Anka-polyphenol containing broth comprising 44˜50% of raw rice based on the total amount of mash, and having an antioxidant activity of 13˜18 TEAC/ml as measured by a DPPH radical elimination method and a brix of 10% or more.

10. An use of the Anka-polyphenol containing broth with high antioxidant activity produced by the process according to claim 1 as an additive in a coffee drink to enhance the antioxidant activity of the coffee drink as well as reduce its sour and bitter tastes and increase its flavor.

11. The use of the Anka-polyphenol containing broth with high antioxidant activity according to claim 10, wherein the content of the Anka-polyphenol containing broth in the coffee drink is 1˜5%.

12. The use of the Anka-polyphenol containing broth with high antioxidant activity according to claim 10, wherein each 1% of the Anka-polyphenol containing broth can increase 15˜20% of the antioxidant activity of the coffee drink as measured by a DPPH radical elimination method.

13. The use of the Anka-polyphenol containing broth with high antioxidant activity according to claim 10, wherein the coffee drink is a milled coffee drink brewed from medium dark to dark roasted coffee beans with Agtron number of 60 or less.

14. The use of the Anka-polyphenol containing broth with high antioxidant activity according to claim 10, wherein the coffee beans comprise a mixture of Costa Rica coffee bean, Brazil Santos coffee bean, Guatemala coffee bean, Tanzania coffee bean and Mandeling coffee bean.

15. The use of the Anka-polyphenol containing broth with high antioxidant activity according to claim 10, wherein the fermentative broth further comprises equal amount of excipients and is sprayed dry to form a powdered Anka-polyphenol containing extract.
